(19) United States
(12) Patent Application Publication
(10) Pub. No.: US 2017/0286374 A1
(43) Pub. Date: Oct. 5, 2017

(54) MARKUP LANGUAGE FOR CREATING RELATIONSHIPS BETWEEN PATENTABLE ENTITIES

(71) Applicants: Eric LENINIGER, New Orleans, LA (US); Mitchell KLEIN, New Orleans, LA (US)

(72) Inventors: Eric LENINIGER, New Orleans, LA (US); Mitchell KLEIN, New Orleans, LA (US)

(21) Appl. No.: 15/507,209

(22) PCT Filed: Aug. 28, 2015
(86) PCT No.: PCT/US15/47605

§ 371 Date: Feb. 27, 2017

Related U.S. Application Data
(60) Provisional application No. 62/043,958, filed on Aug. 29, 2014.

(51) Int. Cl. G06F 17/22; G06F 17/30; G06F 17/27

(52) U.S. Cl. CPC G06F 17/2247; G06F 17/272; G06F 17/30011; G06F 17/30654; G06F 17/30716; G06F 17/30908

(57) ABSTRACT

The present invention is in the technical field of computer-assisted document preparation. A computer software-based mark-up language is disclosed. The computer software-based mark-up language may be written within the existing native code yet not executed by the native code compiler. The computer software-based mark-up language disclosed allows for computer-assisted patent application preparation.

### CROSS-REFERENCE TO RELATED APPLICATIONS

Not Applicable

### STATEMENT REGARDING FEDERALLY FUNDED RESEARCH

Not Applicable

### REFERENCE TO A MICROFICHE APPENDIX

Not applicable

### BACKGROUND OF THE INVENTION

### Field of the Invention/Technical Field

The present invention is in the technical field of computer-assisted document preparation. In a one embodiment, the present invention is in the field of computer-assisted patent application preparation.

### Description of Related Art/Background Art

Computer software often comprises numerous functions, classes and modules which are designed to process data. These software features often leads to very complex functional arrangements. Thus, when inventors of software technology seek patent protection they face a non-trivial obstacle of accurately and completely describing their invention to a patent professional whom endeavors to capture, the patentable steps or elements of the software invention. Inventors and patent practitioners engage in a knowledge extraction process where patent practitioners endeavor to parse the inventive details into a common patent vernacular. Often this entails summarizing software functions using flowcharts depicting logical decisions, for example. However, there is often a knowledge and a lexicographical gap between inventors and patent practitioners. Failure to fill this gap may lead to deficiencies in preparation of the patent application.

The knowledge extraction process comprises steps wherein 1) the inventor must be able to create diagrams that reflect the usage of their system, at least as well to get across to patent practitioner the structure and/or function of the invention elements; 2) the practitioner then queries the inventor as to how an invention is created and what are the benefits that arise from such an organization of inventive elements; and finally, 3) the practitioner prepare drawings that depict the invention.

This lack of communication leads to increased cost for the inventor and potential miscommunication between the inventor and practitioner.

### SUMMARY OF THE INVENTION

One embodiment of the present invention is a computer software-based markup language. One embodiment of the present invention is a standalone computer software-based language, not embedded in a code that allows one or more inventors to designate software entities or elements with metadata. Said metadata may include designations such as classes, libraries, modules and function, while and also establishing relationships between metadata. In one embodiment of the present invention, the computer software-based mark-up language is designed to be written within the existing native code in such a manner that it is not executed by the native code compiler. Thus, in some embodiments the mark-up language may be commented or escaped code, which is parsed and evaluated by a parser and compiler that can read the markup language. After compiling the markup language, the output may be sent to one or more native programming languages, which through existing means or an API (application programming interface), allow the output of the computer software-based mark-up language of the present invention to create flowchart diagrams, interactive views in a document, preferably a specification for a patent application. PCT/US2014/49510 is hereby incorporated by reference.

Embodiments of the present invention employ the art-recognized software architecture for implementing user interfaces known as model-view-controller (MVC) system. In the MVC system, the model structures an area of expertise that must be examined, also known as the problem domain, independent of the user interface. The model directly manages the input data, logic and rules of the application. In the MVC system, the view component generates an output presentation. The view encompasses any representation of information. However, examples include charts and diagrams. Importantly, multiple views of the same information are possible. The third part, the controller, accepts input and converts it to commands for the model or view. For example, the controller may send commands to the model to update the model state (e.g., editing a document). It can also send commands to its associated view to change the view's presentation of the model (e.g., by scrolling through a document).

Embodiments of the present invention create patent drawings and patent text from a markup language.

Embodiments of the present invention create interactive views from a markup language.

Embodiments of the present invention allow for rapid production patent applications, and more preferably, software related patent applications.

Embodiments of the present invention improve communication between an inventor and a patent practitioner while facilitating the knowledge extraction process that allows a patent professional to capture the details of an invention for which patent protection is sought.

Embodiments of the present invention allow rapid depiction of patentable relationships between elements of an invention which aids in producing a patent specification legally compliant to the relevant jurisdiction.

Embodiments of the present invention allow annotation in order to denote relationship between software elements.

Embodiments of the present invention designate connections between elements using symbols (e.g., arrows) and text, which are output as one or more patent drawings (e.g., flow charts and the like).

Embodiments of the present invention designate a hierarchal relationship between elements of an invention wherein one element may encompass another in a parent child-relationship.

Embodiments of the present invention designate inventive elements with a plurality of sub-elements or within a hierarchal context such as a parent-child context.

### BRIEF DESCRIPTION OF THE DRAWINGS

FIG. 1 diagrams the general steps one embodiment of the present invention.

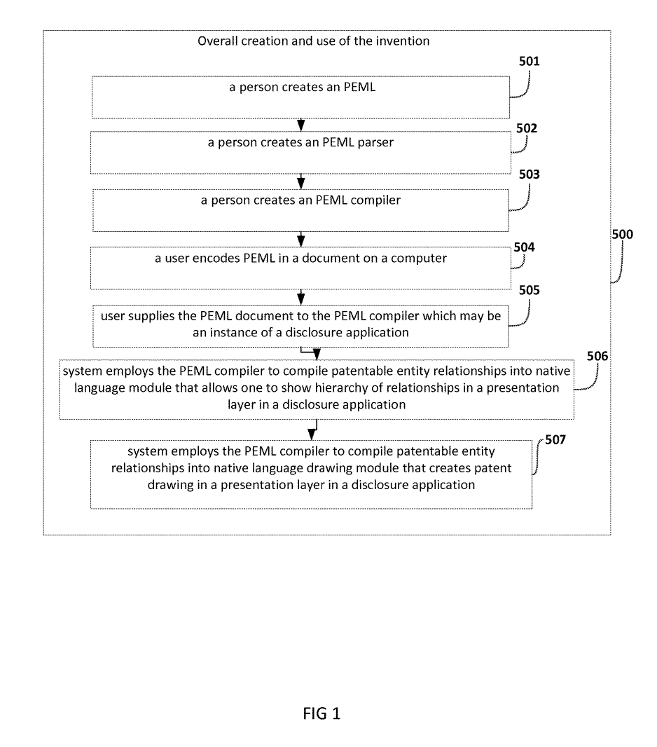

FIG. 2 diagrams the relationships between components of patentable entity/element markup language (PEML) 30 PEML.

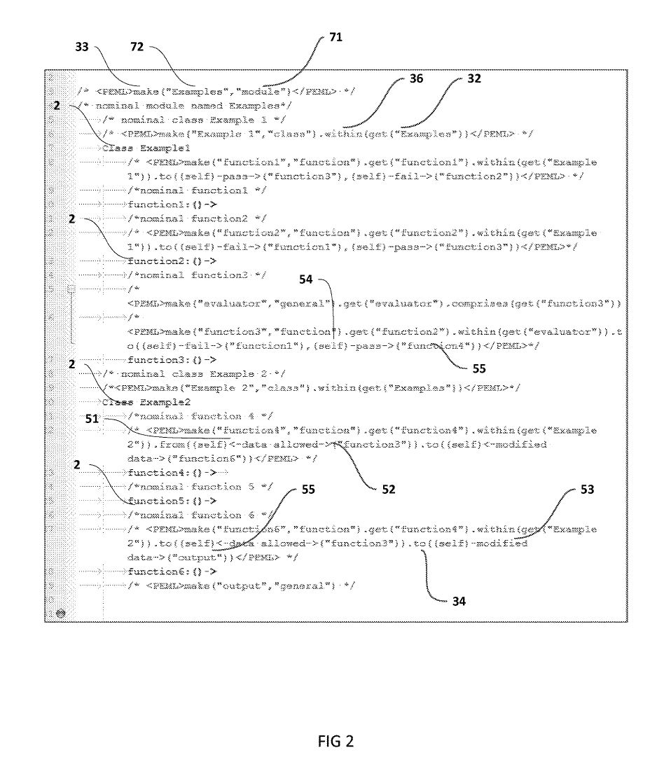

FIG. 3 illustrates the use of the PEML by the syntax of their components embedded within a nominal code.

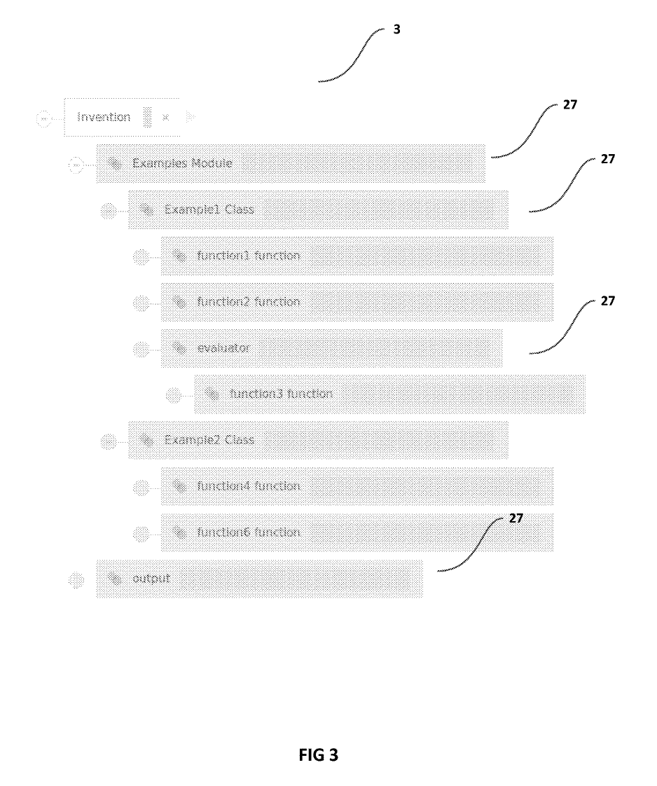

FIG. 4 illustrates a graphical user interface of PEML syntax output.

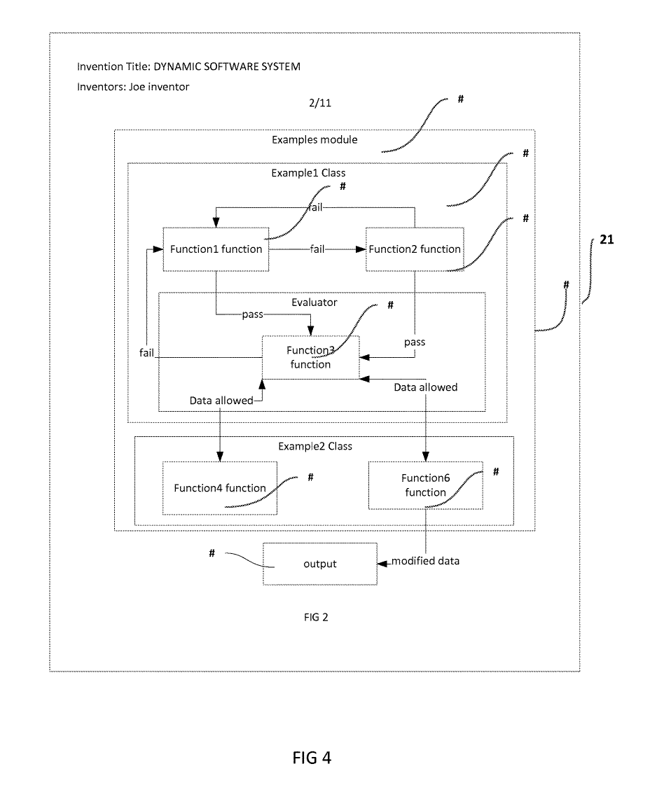

FIG. 5 illustrates a graphical user interface depicting patent drawing output from PEML syntax.

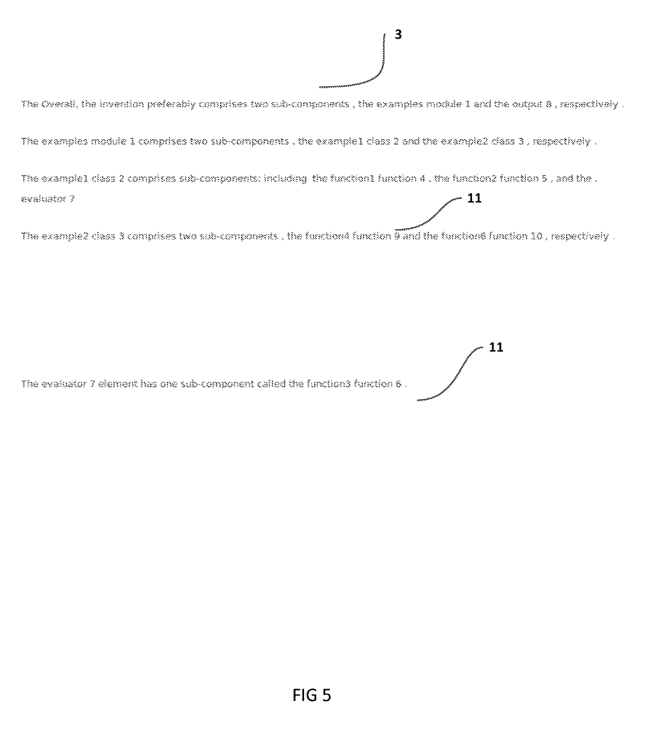

FIG. 6 diagrams the steps for encoding PEML into a document.

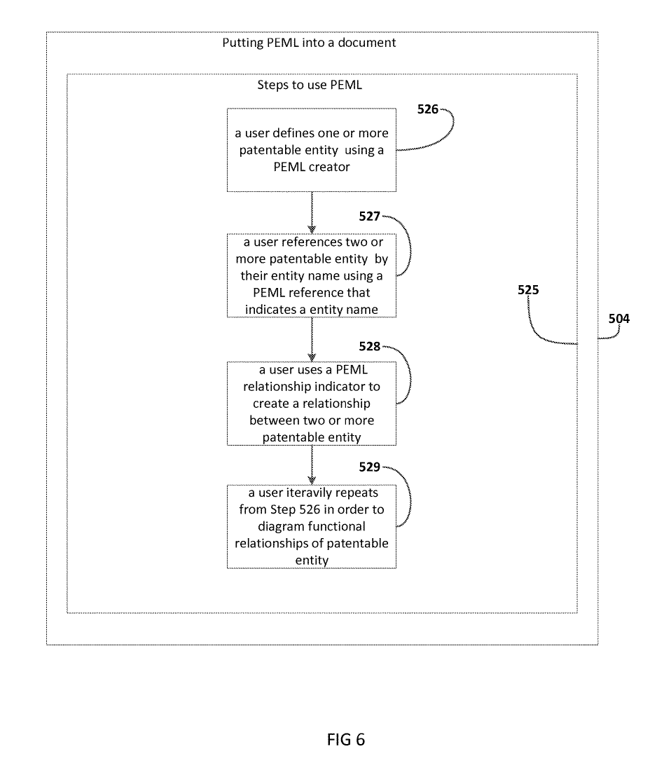

FIG. 7 diagrams steps for creating one or more elements in a PEML document.

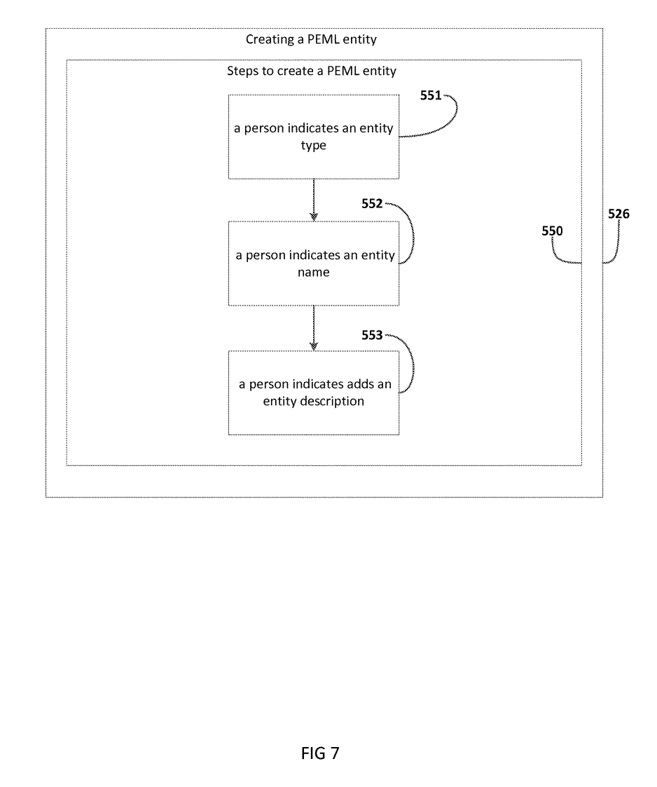

FIG. 8 diagrams steps for creating one or more relationships between two or more patentable elements.

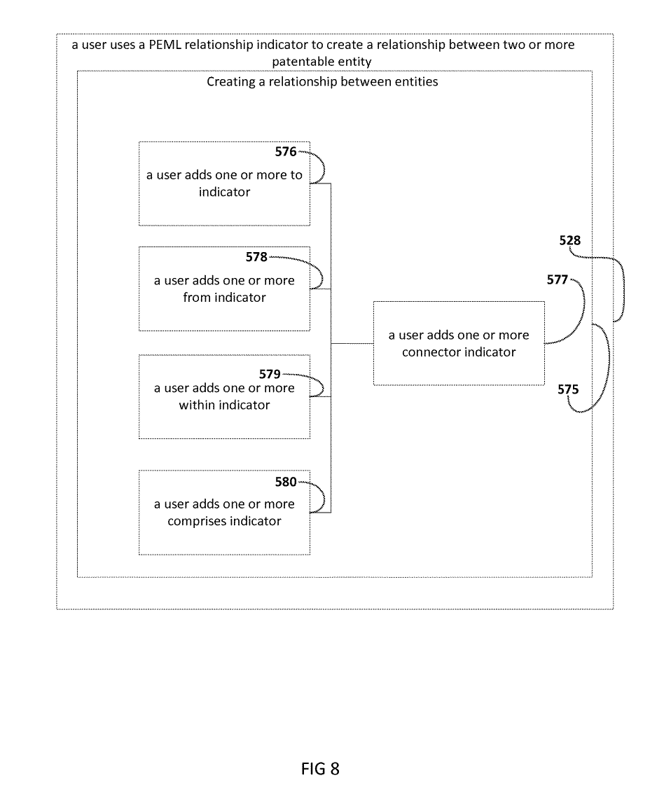

### DETAILED DESCRIPTION OF THE INVENTION

In general it is thought that computer software-based mark-up language of the present invention is a novel system and method rapidly creating document drawings, text, and/or interactive views from an embedded markup language. In one embodiment of the present invention, the computer software-based mark-up language is used on a programming language editor, which may be on any general computing device, such as a mobile computing device, laptop, netbook, server, cell phone, smart phone, personal digital assistant, tablet computer, or any other device capable of executing one or more instructions.

The user device may contain one or more processors, such as processors which may be a central processing unit (cpu), a microprocessor, a general purpose processor, an application specific processor, or any device that executes instructions. The user device and server (which may parse and compile the markup language) may also include one or more memories that store data and compilers, parsers or software modules. The memory may be implemented using any computer-readable storage medium, such as hard drives, CDs, DVDs, flash memory, RAM, ROM, etc. The memory may store a module, or application, or interface, library or engine which allows the may be executed by processor. The user interface for entering the markup language may include one or more of a screen, a display, a projector, a touch panel, a pointing device, a scrolling device, a button, a switch, etc. which may interact with a presentation layer of a module.

One embodiment of the present invention comprises a method hereinto referred to as Method (1) 500. The invention comprises sub steps. User creates a PEML 30 (herein termed the Method (1)—Step (1) 501). The term PEML 30 is thought to encompass an acronym for patentable entity markup language which is a markup language 15 or standalone language with a specific syntax designed to be embedded within existing code that allows one to designate portions of code as having functional relationships to one another and operably communicate with a disclosure application 3 in order to create patent text, disclosure view 27 and/or patent drawing 21. User creates a PEML parser 83, (herein termed the Method (1)—Step (2) 502). The term PEML parser 83 is thought to encompass a means to strip the PEML 30 from the code 2 and process the relationships between the entity name 72 and format the relationships as one or more objects 19 or arrays. User creates a PEML compiler 87, (herein termed the Method (1)—Step (3) 503). User encodes PEML 30 in a document on a computer 13, (herein termed the Method (1)—Step (4) 504). User supplies the PEML 30 document to the PEML compiler 87 which may be an instance of a disclosure application 3, (herein termed the Method (1)—Step (5) 505). System employs the PEML compiler 87 to compile patentable entity 1 relationships into native language 17 module that allows one to show hierarchy of relationships in a presentation layer 7 in a disclosure application 3, (herein termed the Method (1)—Step (6) 506). System employs the PEML compiler 87 to compile patentable entity 1 relationships into native language 17 drawing termed the Method (1)—Step (7) 507) While the steps in Method (1) 500 are depicted in a particular order, the principles of the present disclosure are not limited to the order depicted immediately above.

The Step 504 comprises sub steps: user defines one or more patentable entity/element 1 using a PEML creator 33 (herein termed the Method (2)—Step (1) 526); user references two or more patentable entity 1 by their entity name 72 using a PEML reference 32 that indicates an entity name 72, (herein termed the Method (2)—Step(2) 527); user uses a PEML relationship indicator 31 to create a relationship between two or more patentable entity 1, (herein termed the Method (2)—Step(3) 528); user iteratively repeats from Step 526 in order to diagram functional relationships of patentable entity 1, (herein termed the Method (2)—Step(4) 529). The aforementioned method is herein termed Method (2) 525. While the steps in Method (2) 525 are depicted in a particular order, the principles of the present disclosure are not limited to the order depicted immediately above.

In addition, the Step 526 comprises sub steps. User indicates an entity type 71 (herein termed the Method (3)—Step (1) 551) and then subsequently user indicates an entity name 72 (herein termed the Method (3)—Step (2) 552). The aforementioned method is herein termed Method (3) 550. While the steps in Method (3) 550 are depicted in a particular order, the principles of the present disclosure are not limited to the order depicted immediately above.

Further, the Step 528 comprises sub steps. User adds one or more “to” indicator 34 (herein termed the Method (4)—Step (1) 576) and then subsequently a user adds one or more “connector” indicator 38 (herein termed the Method (4)—Step (2) 577) the aforementioned method is herein termed Method (4) 575. While the steps in Method (4) 575 are depicted in a particular order, the principles of the present disclosure are not limited to the order depicted immediately above.

In some embodiments, Step 576 may further comprise: a step wherein a user adds one or more “from” indicator 35 herein termed the method (4)—step(3) 578; a step wherein a user adds one or more “within” indicator 36 herein termed the method (4)—step(4) 579; a step wherein a user adds one or more “comprises” indicator 37 herein termed the method (4)—step(5) 580; a step wherein a user adds one or more “from” indicator 35 herein termed the method (4)—step(6) 581.

The patentable entity/element markup language (PEML) 30 is intended to both 1) allow easy creation of drawings, such as patent drawing 21 comprising software components, in a document disclosure, such as a patent application disclosure 3, and also to 2) communicate with a disclosure application 3 and have the parsed output of the PEML 30 to be easily visualized in order to understand the relationships between the components. The PEML 30 exists within the native code of the program and is non-complied by the native language by escaping or commenting the PEML.

The PEML 30 preferably comprises 3 accompanying sub-components; the PEML relationship indicator 31, the PEML reference 32, and the PEML creator 33. The term PEML relationship indicator 31 is broadly thought to include a syntactical means to allow a user to designate the flow of the relationship between software components. The term PEML reference 32 is thought to encompass a mean to signify to the PEML parser 83 that the argument for the PEML reference 32 is an entity name 72 and that subsequent operations apply to this entity. The term PEML creator 33 may include a means for an input syntax to identify the entity name 72 as a particular entity type 71 that can be identified by the PEML parser 83.

The PEML creator 33 is intended to both: 1) allow the user to identify something they want to mark as patentable in their code; and 2) define a certain portion of code as having a functional relationship with another piece of code. It preferably comprises two members, the entity type 71 and the entity name 72 which are arguments supplied to the creator (e.g., inventor and/or patent professional). In some embodiments of the present invention, an example syntax comprises be make( )73, new( ) or create( ). In other embodiments, there may be more arguments, such as acronym, description.

Once an entity has been created in can be called by the user by the PEML reference. The PEML reference 32 is designed to both 1) allow the user to call an entity name 72 and apply instructions to that entity name 72 and also to 2) have a simple syntax similar to that of common programming languages. An example syntax in some embodiments may be get( ) retrieve( ) or find( ) with the entity name supplied as the argument. In other embodiments, there may be more arguments, relevant to the function such as passing in an entity type to get an array of all entities of a type or passing selectors to modify the return values if an array of items is returned.

In some embodiments of the present invention, the PEML relationship indicator 31 functions to both 1) demonstrate a connection between one or more entities and 2) demonstrate one or more entities as being a child of another entity (i.e., establish a hierarchal relationship between entities). This allows the users to define relationships from within their code, iteratively. The PEML relationship indicator 31 comprises sub-members further comprising the “to” indicator 34, the “from” indicator 35, the “within” indicator 36, the “comprises” indicator 37, and the “connector” indicator 38. In some embodiments, if the PEML relationship indicator 31 is missing, it may be possible for uses to employ an array of “connector” indicator 38 in order to establish a relationship.

One goal of the “to” indicator 34 is to designate one or more entities that come after an entity. In some embodiments, it is reasonable to contemplate a syntax of the “to” indicator 34 may be also be to( ) 39, next( ) 40, or after( ) 41 with one or more “connector” indicator supplied as arguments.

The “from” indicator 35 is designed to designate one or more entities that come before an entity. In some embodiments, it is reasonable to contemplate a syntax of the “from” indicator 35 to be from( ) 42, before( ) 43, or previous( ) 44 with one or more “connector” indicator supplied as arguments.

One objective of the within indicator 36 is to demonstrate an entity as being child of one or more other entity. In some embodiments, it is reasonable to contemplate a syntax of the “within” indicator 36 could be within( ) 45, parent( ) 46, or of( ) 47 may take the place of the “within” indicator 36. One objective of the “within” indicator 36 with one or more “connector” indicator supplied as arguments.

The “comprises” indicator 37 is designed to demonstrate an entity as having one or more child entities. In some embodiments, it is reasonable to contemplate a syntax of the “comprises” indicator 37 could be either comprise( ) 48, child( ) 49, or kid( ) 50 with one or more “connector” indicator supplied as arguments.

The “connector” indicator 38 aims to allow one to create lines between patent entities in a patent drawing 21 through text. The “connector” indicator 38 comprises; a “self-arrow”51, an “other arrow” 52, a “text region” 53, a “self-reference”54, and an “other reference” 55. The “self-arrow”51 functions to allow the user to create an arrow on a diagram that references the specific object being worked on. The other arrow 52 is intended to allow the user to create an arrow on a diagram that references a non-“self-object” that has relationship to the “self-object”.

The text region 53 is intended to allow the user to designate the type or condition of a relationship. The “self-reference”54 aims to allow the user a way to refer to the instance object or entity name 72. One goal of the other reference 55 is to allow the user a way to refer to a non-instance object by its entity name 72.

The invention comprises numerous terms that are necessary to define the scope of for purposes of interpretation. The definition of these terms below allows numerous embodiments of the invention that may arise. The term PEML 30 is thought to encompass an acronym for patentable entity markup language which is a markup language 15 or standalone language with a specific syntax designed to be embedded within existing code that allows one to designate portions of code as having functional relationships to one another and operably communicate with a disclosure application 3 in order to create patent text, disclosure view 27 and/or patent drawing 21. The term PEML relationship indicator 31 is broadly thought to include a syntactical means to allow a user to designate the flow of the relationship between software components.

The term “connector” indicator 38 is broadly thought to include a syntactical means to designate a patent drawing 21 connection between a “self-reference” 54 and an “other reference” 55. The term “self-arrow”51 is broadly thought to include a portion of the “connector” indicator 38 that syntactically designates an arrow in a drawing that is closest to the reference entity name 72. In some embodiments the term other arrow 52 may include a portion of the “connector” indicator 38 that is syntactically designates an arrow in a drawing that is farthest from the reference entity name 72 and is closest to the other reference 55.

In some embodiments the term text region 53 may include a portion of the “connector” indicator 38 that allows one to describe the relationship between a connection. The term “self-reference” 54 is broadly thought to include a portion of the “connector” indicator 38 that indicates the entity name 72 object. The term other reference 55 is broadly thought to include a portion of the “connector” indicator 38.

The term PEML reference 32 is thought to encompass a mean to signify to the PEML parser 83 that the argument for the PEML reference 32 is an entity name 72 and that subsequent. In some embodiments the term PEML creator 33 may include a means for an input syntax to identify the entity name 72 as a particular entity type 71 that can be identified by the PEML parser 83. In some embodiments the term entity type 71 may include a string reference to a predefined software entity that may have a relationship with another software entity.

In some embodiments the term entity name 72 may include a string the user supplies in order to associate an entity type with a functional piece of software. The term PEML parser 83 is thought to encompass a means to strip the PEML 30 from the code 2 and process the relationships between the entity name 72 and format the relationships as one or more objects 19 or arrays. The term patentable entity 1 is broadly thought to include a module 10 of code that has a functional relationship to another module 10 of code.

In some embodiments the term code 2 may include the text of one or more programming language 16 or object oriented programming 18 language that is the basis of a module 10. The term disclosure application 3 is broadly thought to include software 28 or module 10 in a presentation layer 7 on a user device 24 that allows rapid, input of invention information 26 and outputs patent application text. The term inventor 4 is broadly thought to include any person, or persons in United States patent law, who contribute to the claims of a patentable invention.

In some embodiments the term patent application 5 may include a request pending at a patent office for the grant of a patent for the invention described and claimed within the application. The term element association 6 is broadly thought to include the nested relationship between one or more disclosure view 27 (of possibly different types, such as method having steps or step having sub step or step having element) which may determine different type of sentences generated. In some embodiments the term presentation layer 7 may include graphical output from a module 10 for user interaction typically one or more graphical user interface 101.

The term view 9 is thought to encompass an element of a graphical user interface 101 that displays an information arrangement changeable by the user. The term natural text 11 is thought to encompass text generated from the invention that describes the inventor 4 invention. In some embodiments the term developer 12 may include any person involved with researching, designing, implementing, and/or testing software 28.

The term memory 99 is thought to encompass the physical devices used to store programs (sequences of instructions) or data (e.g., program state information) on a temporary or permanent basis for use in a computer or other digital electronic device. The term operating system 100 is thought to encompass a collection of software that manages computer hardware resources and provides common services for computer programs. The term graphical user interface 101 is broadly thought to include a type of user interface that allows users to interact with electronic devices through graphical icons and visual indicators such as secondary notation, as opposed to text-based interfaces, typed command labels or text navigation.

The term markup language 15 is broadly thought to include a modern system for annotating a document in a way that is syntactically distinguishable from the text. The term programming language 16 is thought to encompass an artificial language designed to communicate instructions to a machine, particularly a computer. The term native language 17 is thought to encompass a programming language 16 familiar to the developer.

The term object oriented programming 18 is thought to encompass a programming paradigm that represents concepts as objects that have data fields (attributes that describe the object) and associated procedures known as methods. The term objects 19 is broadly thought to include an instance of a class or a key-value grouping of values. In some embodiments the term patent drawing 21 may include a drawing required for ascertaining intellectual property, for example which may be a nonprovisional patent drawing 22 or a provisional patent drawing 23.

The term nonprovisional patent drawing 22 is broadly thought to include a drawing that is labeled with numbers representing invention elements or steps or tables that corresponds to the requirements of drawings for the USPTO non provisional application or PCT application. The term provisional patent drawing 23 is thought to encompass a drawing that is labeled with numbers representing invention elements or steps or tables that is used for filing a provisional patent. The term user device 24 is broadly thought to include an interactive device that has a CPU 14 and memory 99 with one or more module 10 containing executable instructions, typically a computer 13.

In some embodiments the term network 25 may include a telecommunications network that allows computers to exchange data. In some embodiments the term invention information 26 may include data related to the function, composition, creation, use, or description of an invention including any claimable limitation. In some embodiments the term disclosure view 27 may include an interactive view 9 within a graphical user interface 101 that is draggable and a crud object 29 and represents a patentable entity 1 within a disclosure application 3.

In some embodiments the term software 28 may include a collection of computer programs and related data. In some embodiments the term crud object 29 may include an acronym for create, read, update and delete graphical user interface 101 objects which are the four basic functions of persistent storage. Also pertains to graphical user interface 101 conventions that facilitate viewing, searching, and changing information for computer 13 forms and reports.

The embodiments described herein, and in the attached documentation, are exemplary only, and it will be apparent to those skilled in the art that various modifications and variations can be made in the disclosed systems and processes without departing from the scope of the invention. Other embodiments of the invention will be apparent to those skilled in the art from consideration of the specification and practice of the invention disclosed herein. It is intended that the specification and examples be considered as exemplary.

We claim:

1) A method for establishing relationships between claimable patentable entities comprising the steps of:
a. creating a language capable of establishing relationships between patentable entities;
b. inputting one or more functional portions of said language into a document stored in memory;
c. submitting said document to a parser and/or compiler; and,
d. outputting views through a presentation layer module.

2) A system for establishing relationships between claimable patentable entities comprising:
a. a language capable of establishing relationships between patentable entities a parser and/or compiler; and,
b. a presentation layer module that graphically illustrates invention entities.
